(19) United States
(12) Patent Application Publication
(10) Pub. No.: US 2007/0140084 A1
(43) Pub. Date: Jun. 21, 2007

(54) Information recording/reproducing apparatus, and method for checking and presenting information

(75) Inventor: Norikatsu Chiba, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/540,602

(22) Filed: Oct. 2, 2006

(30) Foreign Application Priority Data
Dec. 19, 2005 (JP) 2005-365244

(51) Int. Cl. G11B 15/52

(52) U.S. Cl. 369/52.1

(57) ABSTRACT

An information table storage stores an information table. The information table includes information regarding contents of an optical disk, disk identification information, and specific information representing relationships between the optical disk and an apparatus. An identification information detector section detects identification information when the optical disk is loaded in the apparatus. A search section searches the information table to see whether the identification information detected by the identification detector section is included in the information table. A specific information processor section determines whether the specific information read out from the optical disk corresponds to a currently-used apparatus. A notification processor supplies relevant information to a user interface where the identification information is included in the information table and the readout specific information corresponds to the currently-used apparatus.

### CROSS-REFERENCE TO RELATED APPLICATIONS

This application is based upon and claims the benefit of priority from Japanese Patent Application No. 2005-365244, filed Dec. 19, 2005, the entire contents of which are incorporated herein by reference.

### BACKGROUND

1. Field

One embodiment of the invention relates to an information recording/reproducing apparatus and a method for checking and presenting information recorded thereby. More specifically, the present invention relates to a technology that enables a user to easily identify the recorded contents of a number of removable disks, thereby improving the usability of the recording/reproducing apparatus.

2. Description of the Related Art

Recently, optical disks such as digital versatile disks (DVDs) are in wide use, and digital data on music and movies can be accumulated in them as digital video/audio works. An information recording/reproducing apparatus used for playing the DVDs is provided with an internal hard disk drive, and is used not only for playing the DVDs but also for recording broadcast programs.

The user sometimes wants to back up programs recorded in the hard disk of the information recording/reproducing apparatus. Therefore, the user may own a large number of DVDs in which the programs are backed up.

Sometimes, how to manage the DVDs becomes a problem. If the user has a large number of DVDs, it is difficult to know in which disk the program the user would like to view is stored, or what is stored in each disk.

A technology for solving this problem is described in Jpn. Pat. Appln. KOKAI Publication No. 2003-173541. This publication discloses a recording/reproducing system configured to read the ID of an optical disk and display content information which is stored in a storage device corresponding to that ID.

In order to permit the user to check the contents of optical disks, the following methods are available. One of the methods is to record data in an optical disk in such a manner as to permit the user to visually confirm the content information. Another method is to record content information in a recording area of an optical disk and display it when data is reproduced.

To record the visually confirmable information in an optical disk, the recording/reproducing apparatus must use a special type of recording means, which makes the recording/reproducing apparatus expensive. In addition, the processing performed after the end of a recording operation takes time. Likewise, the second method (i.e., the method which records content information in a recording area of an optical disk) is similar to the first method in that the processing performed after the end of a recording operation takes time. Since the content information is read out from the optical disk at the time of reproduction, the second method is not advantageous in terms of the time required.

Accordingly, an object of the present invention is to provide an information recording/reproducing apparatus and an information checking/presenting method, which enable easy management of content information regarding removable information recording mediums, and which enables fast processing of the content information. Another object of the present invention is to provide an information recording/reproducing apparatus and an information checking/presenting method, which provide a function of checking and presenting recorded contents, and which easily detects a state where another information recording/reproducing apparatus overwrites or rewrites the data in a removable information recording medium or adds new data to the removable information recording medium, thereby preventing the user from making an incorrect determination.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 illustrates the configuration according to a first embodiment of the invention.

FIG. 2 shows an example of an information table provided in the nonvolatile storage device 104 shown in FIG. 1 according to the first embodiment of the invention.

FIG. 3 shows an example of an optical disk according to the first embodiment of the invention.

FIG. 4 is a flowchart illustrating an example of an operation the apparatus performs according to the first embodiment of the invention.

FIG. 5 is an explanatory view showing examples of what the display device of the apparatus displays according to the first embodiment of the invention.

FIG. 6 is a flowchart illustrating how an apparatus according to a second embodiment of the invention.

FIG. 7 illustrates still another embodiment of the invention.

FIG. 8 illustrates still another embodiment of the invention.

FIG. 9 illustrates still another embodiment of the invention.

### DETAILED DESCRIPTION

Various embodiments according to the invention will be described hereinafter with reference to the accompanying drawings. In general, according to one embodiment of the invention, an information recording/reproducing apparatus comprises: an information table storage that stores an information table recorded beforehand, the information table including: (i) information regarding recorded contents of a removable information recording medium (ii) disk identification information regarding a burst cutting area of the information recording medium (iii) specific information representing relationships between the information recording medium and the apparatus, which are correlated to one another an identification information detector section configured to detect identification information from an information recording medium when this information recording medium is loaded in the apparatus a search section configured to search the information table to see whether the identification information detected by the identification detector section is included in the information table a specific information processor section configured to determine whether the specific information read out from the information recording medium corresponds to a currently-used apparatus and a notification processor configured to supply relevant information corresponding to the identification information and related to contents of recorded information to a user interface, where a search result obtained by the search section shows that the identification information is included in the information table and the readout specific information corresponds to the currently-used apparatus.

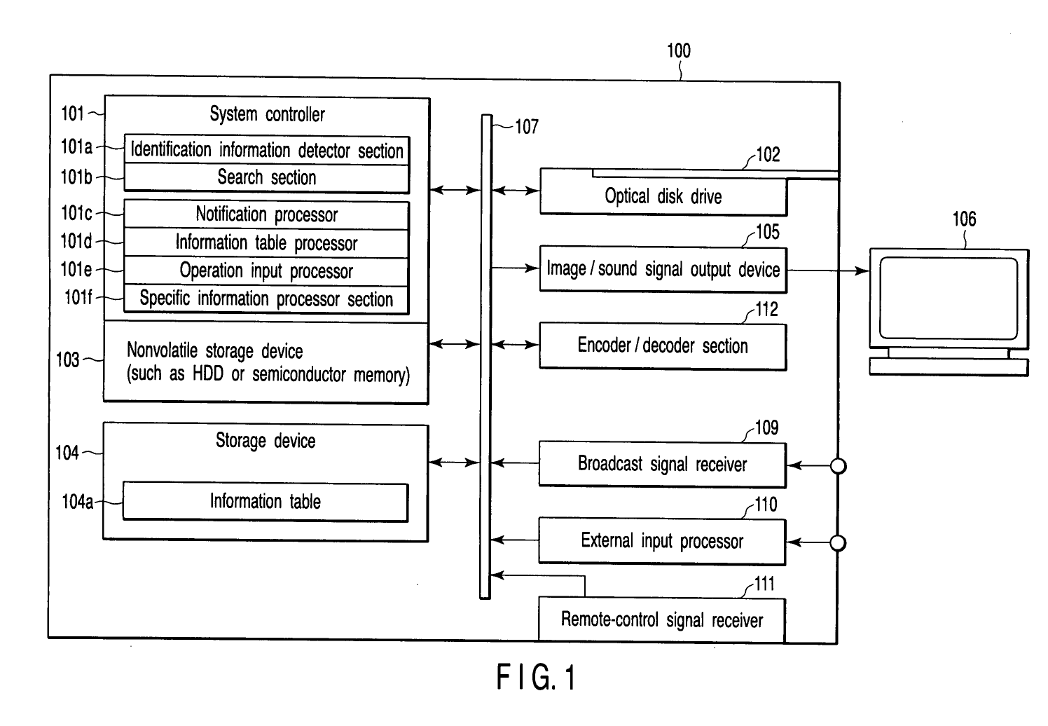

Embodiments of the present invention will now be described with reference to the accompanying drawings. FIG. 1 is a block diagram illustrating the fundamental concept underlying an apparatus of the invention.

Referring to FIG. 1, reference numeral 100 denotes an information recording/reproducing apparatus. The information recording/reproducing apparatus 100 comprises an internal HDD and an optical disk drive 102. An optical disk such as DVD-R, DVD-RW, DVD-RAM, etc. can be loaded in the optical disk drive 102. Reference 101 denotes a system controller including a microcomputer. Reference numeral 103 denotes an HDD. The HDD 103 may be replaced by a semiconductor memory as long as it is a nonvolatile storage device.

Reference numeral 104 denotes a storage device such as a nonvolatile or volatile semiconductor memory. Reference numeral 105 denotes an image/sound signal output device. From the image/sound signal output device 105, signals supplied from the HDD 103, storage device 104 or optical disk drive 102 are output to a display device 106, which is a user interface. The system controller 101, optical disk drive 102, HDD 103, storage device 104 and image/sound signal output device 105 are connected to each other through a bus 107. A broadcast signal receiver 109, an external input processor 110 and a remote-control signal receiver 111 are connected to the bus 107.

The system controller 101 controls the HDD 103, storage device 104, optical disk drive 102 and image/sound signal output device 105 by supplying control signals to them by way of the bus 107. The system controller 101 also controls the broadcast signal receiver 109, external input processor 110 and remote-control signal receiver 111.

The system controller 101 includes an identification information detector 101a, a search section 101b, a notification processor 101c, an information table processor 101d and an operation input processor 101e. The system controller also includes specific value processor 101f (i.e., a hash value processor). How these structural units of the system controller 101 operate and how they are related to each other will be described later.

Let us assume that a program recorded in the hard disk (which is used as the nonvolatile storage device 103) is moved to an optical disk loaded in the optical disk drive 102. In this case, the system controller 101 correlates the information recorded in the optical disk to the identification information on the burst cutting area of the optical disk. Information obtained by this correlation is stored in an information table 104a which is provided in either the nonvolatile storage device 103 or the storage device 104. Reference numeral 112 denotes an encoder/decoder section. The encoder/decoder section 112 receives broadcast signals and format them before they are compressed and recorded in the nonvolatile storage device 103 or an optical disk. The encoder/decoder section 112 performs inverted formatting with respect to signals reproduced from the nonvolatile storage device 103 or optical disk. Part of the nonvolatile storage device (HDD) 103 may be used as storage device 104.

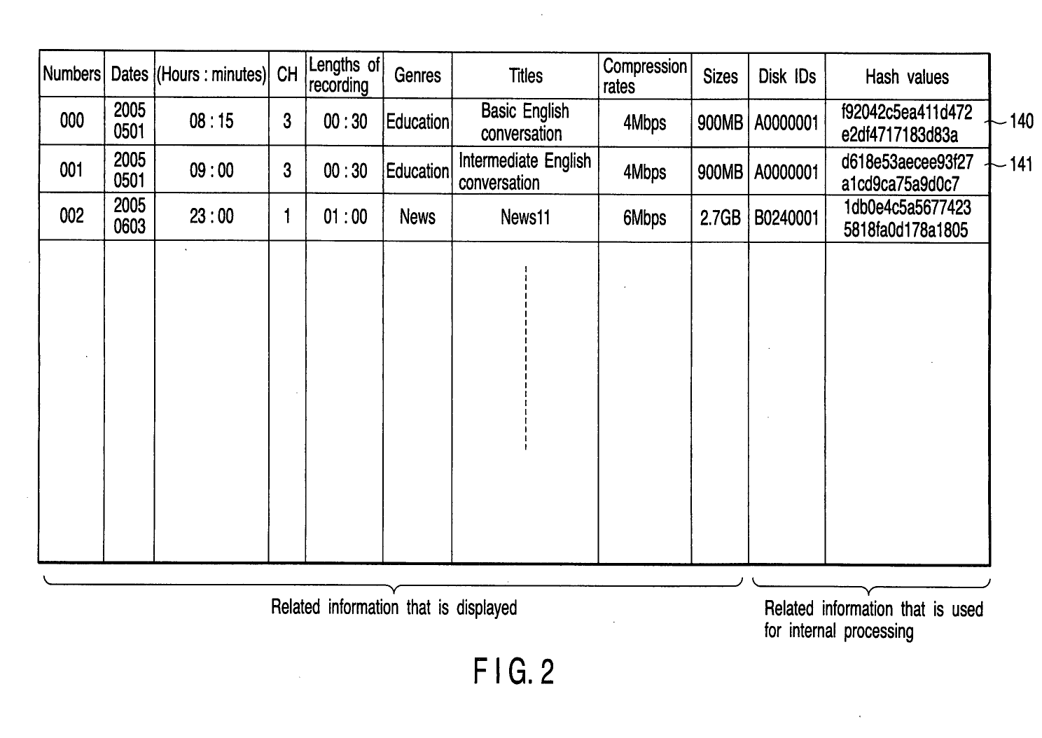

FIG. 2 shows an example of the information table 104a described above. The numbers in the first column CL1 from the left represent an order in which disks are handled by the apparatus. The numbers in the second column CL2 represent when the disks are handled (years, months and days). The numbers in the third column CL3 represent how long the disks are used. The numbers in the fourth column CL4 represent broadcast channels. The numbers in the fifth column CL5 represent the lengths of recording. The data in the sixth column CL6 represents genres. The data in the seventh column CL7 represents titles. The data in the eight column CL8 represents compression rates. The data in the ninth column CL9 represents data sizes. The data in the tenth column CL10 represents disk IDs. The data in the eleventh column CL11 represents hash values.

The hash values, which are indicated by numerals 140 and 141, for example, are values of specific information. The specific information is obtained by use of the ID of the subject information recording/reproducing apparatus and relevant information such as a disk ID or title name. Even if the ID of the loaded disk is the same as a disk ID specified in the table, there may be a case where the hash value described in the table differs from that described in the loaded disk. In this case, it is presumed that the disk was handled by an information recording/reproducing apparatus different from the subject apparatus. It is possible that the disk was handled by another information recording/reproducing apparatus to add the recording of contents to the disk, erase recordings from the disk, or overwrite recordings stored in the disk.

The information table 104a is prepared by the information table processor 101d and stored in either storage device 103 or 104. The information table processor 101d processes information to be stored in the information table 104a.

The hash value (i.e., the specific information described above) need not be stored in the information table of the apparatus. Instead of storing the hash value in the information table, a hash value or a specific value which is uniquely obtained when the corresponding apparatus executes a predetermined operation may be stored in the optical disk.

When the optical disk is loaded in a compatible apparatus, the hash value or specific value is read out from the optical disk and checked by use of an apparatus ID uniquely determined with respect to the apparatus. If the readout hash or specific value is correct, it is confirmed that the disk was handled by the apparatus. As processing for this confirmation, predetermined calculation (e.g., multiplication or division) is carried out based on the apparatus ID and the specific value of the optical disk, and a value obtained by the calculation is compared with a predetermined value. When the value obtained by the calculation is the same as the predetermined value, the disk is regarded as being compatible with the apparatus.

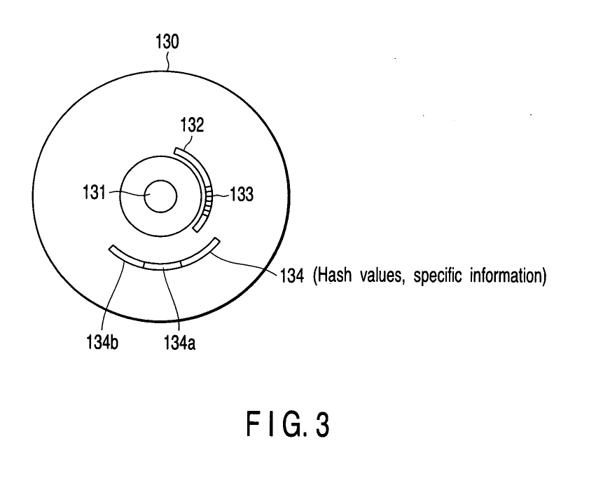

FIG. 3 shows an optical disk 130. In FIG. 3, reference numeral 131 denotes a hole, and reference numeral 132 denotes a burst cutting area (BCA). A disk ID 133 is recorded in the burst cutting area 132. The information-recordable areas of the optical disk 130 include a hash write area 134. The hash value is processed by the specific value processor 101f.

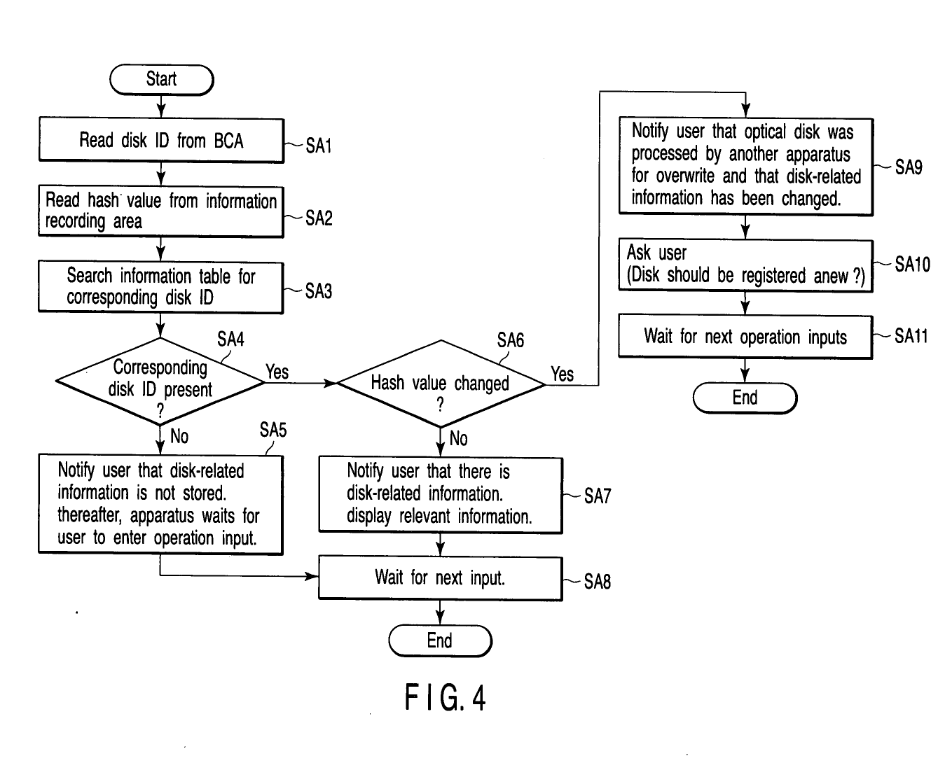

FIG. 4 is a flowchart illustrating the operation of the above apparatus. When an optical disk is loaded in the disk drive 102, the identification information detector 101a reads a disk ID from a BCA (Step SA1). Then, a hash value is read from the predetermined write area (Step SA2).

Then, the search section 101b searches the information table 104a for a disk ID corresponding to the readout disk ID (Step SA3). If the corresponding disk ID is not searched for, the notification processor 101c notifies the user that disk-related information is not stored in the information table 104a (Steps SA4 and SA5), and the apparatus waits for the user to enter an operation input. In this case, since the loaded optical disk was not handled before, an enquiry is made as to whether the information on the loaded optical disk should be registered in the information table 104a. The apparatus may be configured to register the information on the loaded optical disk in such circumstances.

If it is found out in step SA4 that the information table contains a disk ID that is the same as the ID of the loaded optical disk, then the control flow moves on to Step SA6. In Step SA6, the confirmation of a hash value is carried out. To be more specific, it is determined whether the hash value is an original value corresponding to the disk and apparatus.

If it is determined that the hash value is an original value, the notification processor 101c notifies the user that there is disk-related information (Step SA7). If it is determined that the hash value was not changed, the apparatus waits for the next user's input (Step SA8). The display device 106 displays relevant information, including titles recorded in the optical disk. The operations following the display operation are a disk ejection operation, an additional recording operation, a reproduction operation, an initializing operation, etc.

If it is determined in step SA6 that the hash value was changed (it is different from the original value), the user is notified that the related information has been changed (it is different from the original information). In this case, it is probable that the optical disk was processed by another recording/reproduction apparatus for overwrite, erasure or additional recording of contents.

In the case of DVD-RAM or DVD-RW, overwrite or deletion of contents may have been performed after an optical disk is processed by recording/reproducing apparatus A and recording/reproducing apparatus B. In other words, all relevant information may be changed. In this case, the user is asked whether the disk should be registered anew (for overwrite or erasure of contents) (Step SA10). In other words, the user is asked whether the optical disk should be registered as a disk exclusively used as the current recording/reproducing apparatus, and then waits for the next operation (Step SA11). To be more specific, the apparatus waits for operation inputs related to the reproduction processing, image recording processing, erasure processing, registration processing, etc.

Disks are handled in slightly different ways between DVD-RAM and DVD-RW on one hand and write-once DVD-R. Where the write-once DVD-R is used by both recording/reproducing apparatuses A and B, a plurality of hash values are recorded in the disk because the disk is a write-once disk.

After the hash values are recorded, the disk becomes usable by both recording/reproducing apparatuses A and B. In this case, a message indicating that the disk (DVD-R) can be used by both recording/reproducing apparatuses A and B is shown to the user. Needless to say, what was described above is applicable to not only DVD-R but also DVD-RAM and DVD-RW. By recording a plurality of hash values or specific values in these types of disks, they become usable by different recording/reproduction apparatuses.

As described above, the information table 104a is provided, and related information which is correlated to the disk ID of the optical disk is stored in the information table 104a. Thanks to this feature, the user can sequentially load a large number of optical disks in the optical disk drive 102 and quickly confirm what is recorded in them.

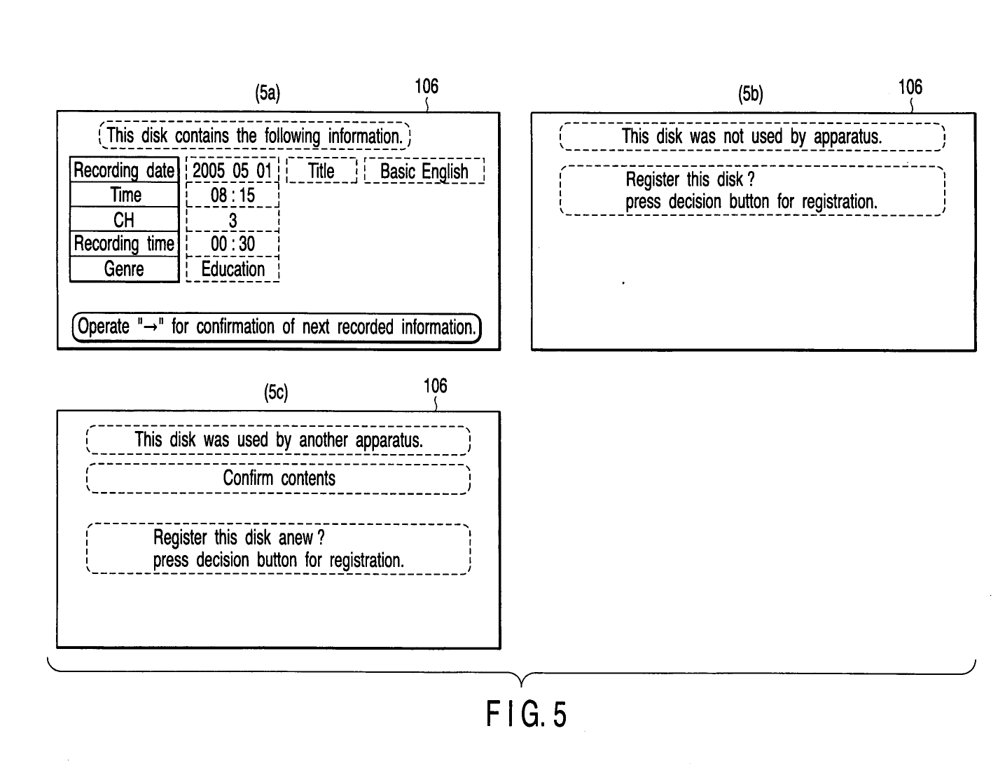

FIG. 5 shows examples of what the display device 106 displays. To be more specific, (5a) illustrates the case where the disk ID of a loaded optical disk is included in the information table, and the hash value of the loaded optical disk is an original value. In this case, the display device 106 displays a display content of the information table. In FIG. 5, (5b) illustrates the case where the disk ID of a loaded optical disk is not included in the information table. In this case, the display device 106 displays operation guide messages such as “This disk was not used by the apparatus” and “Do you want to register this disk? Press the decision button for registration.” In FIG. 5, (5c) illustrates the case where the disk ID of a loaded optical disk is included in the information table, but the hash value of the loaded optical disk is different from an original value. In this case, the display device 106 displays a display content of the information table. In this case, the display device 106 displays messages such as “This disk was used by another apparatus” and “Confirm the contents”, or “Do you want to register this disk anew? Press the decision button for registration.”

The processing described above enables the user to own a large number of information-recorded disks and quickly confirm the contents of the disks. In addition, the compatibility of the disks with the recording/reproducing apparatus in use can be readily checked. Even if a disk is used by another apparatus, it can be registered anew as a disk exclusively used by the subject apparatus. After this registration, the disk can be searched easily.

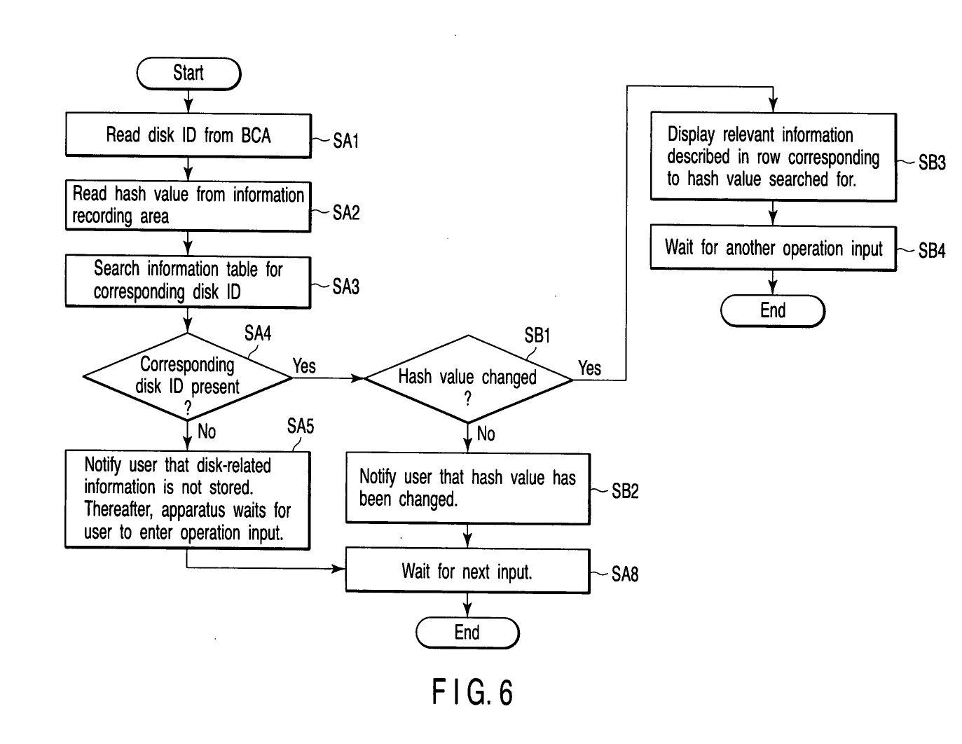

The present invention is not limited to the embodiment described above. If an optical disk is handled by a plurality of recording/reproducing apparatuses, it may happen that hash values of the apparatuses are written in the same optical disk. In other words, a plurality of hash values corresponding to the apparatuses may be written in the optical disk, as indicated by “134a ” and “134b ” in FIG. 3. In this case, the apparatus performs the processing shown in FIG. 6.

In FIG. 6, the same reference symbols as used in FIG. 4 denote similar or corresponding steps. Referring to FIG. 6, where a loaded optical disk contains a plurality of hash values, they are read from the disk when the disk ID is searched for. The hash values are checked to see if they include the hash value corresponding to the apparatus (Step SB1). If the hash value corresponding to the apparatus is not searched for, the data in the optical disk may have been updated or changed. The user is informed of this state by means of a message shown on the display or sound or voice data (Step SB2). When the hash value corresponding to the apparatus is searched for, the relevant information is shown on the display and the apparatus waits for another operation input (Steps SB3 and SB4).

The specific information (e.g., hash values) the specific information processor section (101f) processes need not be prepared in the above-mentioned method; it may be prepared in a variety of methods. For example, (1) one specific information may be prepared in such a way as to correspond to all different contents (specific information corresponding to all contents). Alternatively, (2) one specific information may be prepared for each of the contents (specific information corresponding to each content). (3) Methods (1) and (2) may be combined. In addition, (4) the contents may be classified into groups, and one specific information may be prepared for the contents of each group.

Where the methods described above are combined, the following advantages are produced. That is, whether or not an optical disk is handled by another apparatus can be determined by analyzing the specific information corresponding to all contents. If the optical disk is handled by another apparatus, the specific information corresponding to each content or each group of contents is analyzed to determine which content or which group of contents has been changed.

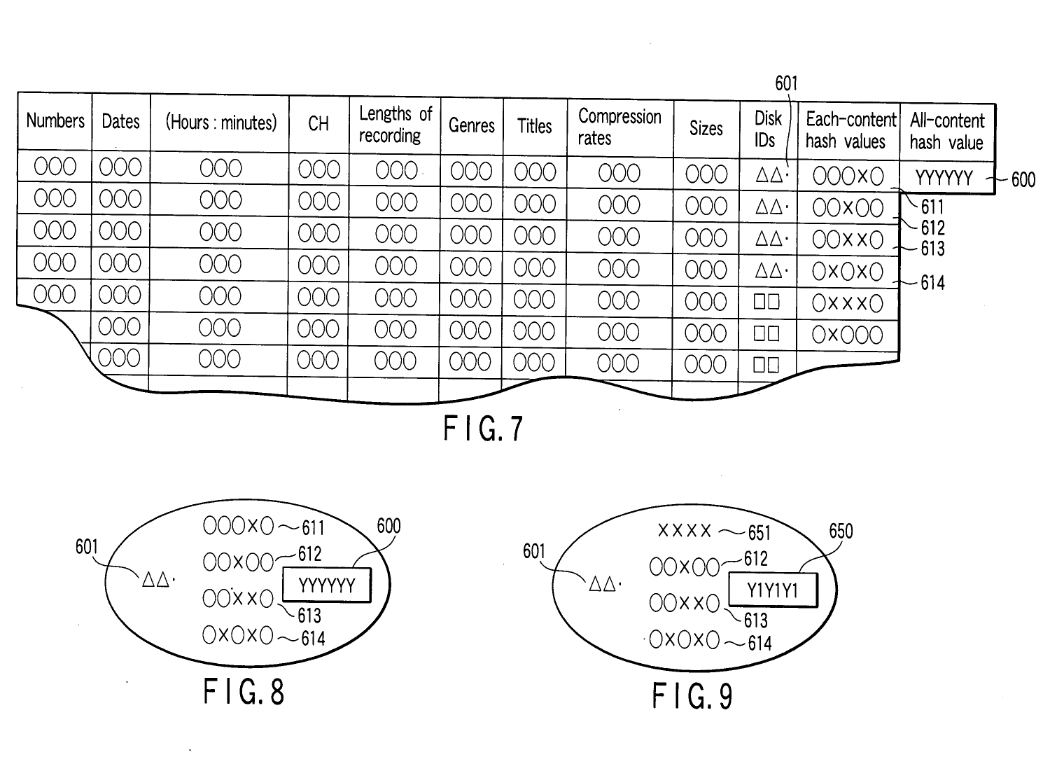

FIG. 7, FIG. 8 and FIG. 9 show an information table containing both the specific information corresponding to all contents (all-content hash values) and the specific information corresponding to each content (each-content hash values). FIG. 7, FIG. 8 and FIG. 9 also show how the specific information table is related to specific information recorded in disks. Let us assume that the information table shown in FIG. 7 is stored in the storage device 104 of recording/reproducing apparatus A, and that the disk 130 having a disk ID of “601” is used by recording/reproducing apparatus A to record three contents corresponding to each-content hash values 611-614. In this case, the disk 130 stores each-content hash values which are the same as hash values 611-614, as shown in FIG. 8. The disk 130 also stores all-content hash value 600 that associates the disk with recording/reproducing apparatus A.

If the disk described above is used by another recording/reproducing apparatus B and one of the contents in the disk are rewritten, the all-content hash value is rewritten as “650” and the each-content hash value corresponding to the rewritten content is rewritten as “651”, as shown in FIG. 9. The other hash values 612, 613 and 614 are not rewritten.

If the disk described above is used by recording/reproducing apparatus A again, recording/reproducing apparatus A determines that the all-content hash value has been changed. Based on this determination, recording/reproduction apparatus A displays a message such as “This disk was used by another apparatus”, as shown in portion (5c) of FIG. 5. On the other hand, where the disk shown in FIG. 7 is used, recording/reproducing apparatus A detects the each-content hash values and can therefore easily determine which content has been changed. In this case, apparatus A shows the title name corresponding to each-content hash value 651 and displays a message such as “The following content has been changed.”

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording/reproducing apparatus comprising:
an information table storage that stores an information table recorded beforehand, the information table including: (i) information regarding recorded contents of a removable information recording medium; (ii) disk identification information regarding a burst cutting area of the information recording medium; (iii) specific information representing relationships between the information recording medium and the apparatus, which are correlated to one another;
an identification information detector section configured to detect identification information from an information recording medium when this information recording medium is loaded in the apparatus;
a search section configured to search the information table to see whether the identification information detected by the identification detector section is included in the information table;
a specific information processor section configured to determine whether the specific information read out from the information recording medium corresponds to a currently-used apparatus; and
a notification processor configured to supply relevant information corresponding to the identification information and related to contents of recorded information to a user interface, where a search result obtained by the search section shows that the identification information is included in the information table and the readout specific information corresponds to the currently-used apparatus.

2. The information recording/reproducing apparatus according to claim 1, wherein the specific information is uniquely obtained by use of the information regarding recorded contents and the information regarding the apparatus.

3. The information recording/reproducing apparatus according to claim 1, wherein the information table storage is incorporated in the apparatus and included in a nonvolatile storage device having a hard disk that enables recording/reproduction of visual information.

4. The information recording/reproducing apparatus according to claim 1, wherein the information table storage is a dedicated semiconductor memory incorporated in the apparatus.

5. The information recording/reproducing apparatus according to claim 1, wherein the notification processor includes means for displaying a message indicating that the information recording medium has not been handled by the apparatus, where the identification information is not included in the information table.

6. The information recording/reproducing apparatus according to claim 1, wherein the notification processor includes means for displaying a message indicating that the information recording medium has been used by another apparatus, where the identification information is included in the information table but the specific information does not correspond to the currently-used apparatus.

7. The information recording/reproducing apparatus according to claim 1, further comprising an information table processor section, wherein, where the identification information detected by the identification information detector section is not included in the information table, the information table processor section registers the identification information in the information table.

8. A method for checking and presenting information recorded in an optical disk, the method using: (i) an optical disk drive in which the optical disk can be loaded; (ii) a nonvolatile driving device configured to drive a hard disk; (iii) a visual/audio signal output device configured to output data reproduced from the optical disk and the hard disk to a display device; and (iv) a system controller configured to control operations,
the method comprising:
recording an information table in an information table storage beforehand, the information table including: (i) information regarding recorded contents of the optical disk; (ii) disk identification information regarding a burst cutting area of the optical disk; (iii) specific information representing relationships between the optical disk and the apparatus, which are correlated to one another;
detecting identification information from an optical disk when this optical disk is loaded in the apparatus;
searching the information table to see whether the detected identification information is included in the information table;
determining whether the specific information corresponds to a currently-used apparatus; and
displaying relevant information corresponding to the identification information and related to contents of recorded information, where a search result shows that the identification information is included in the information table and the specific information corresponds to the currently-used apparatus.

9. The method according to claim 8, wherein a message is displayed indicating that the optical disk has not been handled by the apparatus, where the identification information is not included in the information table.

10. The method according to claim 8, wherein a message is displayed indicating that the optical disk has been used by another apparatus, where the identification information is included in the information table but the specific information does not correspond to the currently-used apparatus.

11. The method according to claim 8, wherein the specific information representing relationships between the optical disk and the apparatus includes:
each-content specific information corresponding to each of contents recorded in the optical disk; and
all-content specific information used for specifying the optical disk.

12. The method according to claim 8, wherein the specific information representing relationships between the optical disk and the apparatus includes:
each-content specific information corresponding to each group of contents recorded in the optical disk; and
all-content specific information used for specifying the optical disk.
